(19) United States
(12) Patent Application Publication
(10) Pub. No.: US 2013/0236237 A1
(43) Pub. Date: Sep. 12, 2013

(54) TELESCOPIC HOT STICK WITH BUTTON CAPTURE FEATURE

(71) Applicant: Mark A. SCHMIDT, Hastings, MI (US)

(72) Inventor: Mark A. SCHMIDT, Hastings, MI (US)

(21) Appl. No.: 13/415,297

(22) Filed: Mar. 8, 2012

(51) Int. Cl. F16B 7/10

(52) U.S. Cl. 403/109.3

(57) ABSTRACT

A multi-section telescoping pole including a tubular first section having a female end and an interior which defines an axial path. A second section has a male end slidably engaged within the interior of the first section through the female end and being slidable along the axial path. An internal annular groove is provided adjacent a distal end of the pole section remote from a proximal end and having a button receiving opening in the annular groove. The annular groove is configured to capture the button when the first and second sections are telescopically extended so that once the button has been captured in the groove, all that the user need do thereafter is to rotate one pole section relative to another to align the button now captured in the groove with the button receiving opening to secure the two pole sections together.

### FIELD OF THE INVENTION

The invention relates to an improvement to the general type of hot stick device, a representative example of which is disclosed in U.S. Pat. No. 5,593,196, namely, a multi-section telescopic pole for manipulating a tool from a position a selected distance away from a workpiece and, more particularly, to an improved button capturing groove on the inside of the pole sections.

### BACKGROUND OF THE INVENTION

Telescopic hot sticks are typically used in a high voltage electrical environment as well as other environments where a long reach is needed to access a workpiece located at a remote location, such as on a power pole or the like. Hot sticks are typically constructed of a suitable dielectric material and include a tool holder at an extremity thereof. The tool holder is adaptable to engage a wide array of different tools or the like. One such hot stick is disclosed in U.S. Pat. No. 5,593,196, the entirety of the disclosure in this patent being incorporated herein by reference.

The hot stick disclosed in U.S. Pat. No. 5,593,196 allows a user to perform a wide variety of tasks such as opening and closing various types of switches, replacing fuses, pruning tree limbs or replacing lamps in street circuits and rooms with high ceilings. Since the workpiece may be as far as 30 feet or more away from a user, the telescoping hot stick or pole provide a variable length to accommodate these tasks.

In U.S. Pat. No. 5,593,196, the tubular sections are non-circular. It is desirous to provide tubular sections that are circular in cross section. One of the issues that arises when the user wishes to extend or collapse the pole sections that are circular in cross section is that the button does not easily become aligned with the button receiving opening when the respective pole sections are being extended relative to one another. That is, the user must be careful not to over extend the pole sections relative to one another because the inner pole section may inadvertently be moved axially beyond the end of the outer pole section. Furthermore, the user must also rotate one pole section relative to the other pole section while adjusting the relative axial positions of the two pole sections until the button and the button opening become axially aligned with one another to allow the button to enter into the button opening to thereby securing the pole sections together and prevent relative rotation therebetween.

Accordingly, it is an object of this invention to provide a telescoping pole assembly having circular cross sections which includes a pole locking assembly having an internal annular groove adjacent to an end of the pole section remote from the proximal end and having a button receiving opening in the annular groove, the annular groove being configured to capture the button when the button is slidingly moved from the proximal end toward the distal end of the pole section so that once the button has been captured in the annular groove, all that the user need do thereafter is to rotate one pole section relative to another to align the button now captured in the annular groove with the button receiving opening to secure the two pole sections together.

It is a further object of this invention to enable any two mutually adjacent and telescoped pole sections to be separated from one another without the use of tools.

### SUMMARY OF THE INVENTION

The objects and purposes of the invention have been met by providing a multi-section telescoping pole for manipulating a tool located at a distal end from a proximal position a selected distance away from a workpiece and including a tubular first section having a female end and a predetermined shape such as circular, the first section having a first aperture and an interior which defines an axial path and has an interior surface which is uniform about a periphery thereof. A second section has a male end slidably engaged within the interior of the first section through the female end and having a second aperture and a predetermined shape corresponding to the shape of the first section and being slidable along the axial path. An internal annular groove is provided adjacent to an end of the pole section remote from the proximal end and having a button receiving opening in the groove, the annular groove being configured to capture the button when the button is slidingly moved from the proximal end toward the distal end of pole section so that once the button has been captured in the annular groove, all that the user need do thereafter is to rotate one pole section relative to another to align the button now captured in the annular groove with the button receiving opening to cause the button to enter, caused by the urging of a resilient member, the button receiving opening to secure the two pole sections together. In addition, once the button is urged radially inwardly so that the radially outwardly facing surface of the button becomes located radially inside the interior surface, the telescoped pole sections can be moved axially relative to one another in either direction.

### BRIEF DESCRIPTION OF THE DRAWINGS

FIG. 1 is a broken front elevational view of the telescoping hot stick of the invention illustrated in the fully extended position;

FIG. 2 is a front elevational view of the telescoping hot stick illustrating a plurality of sections collapsed one within the other;

FIG. 3 is a sectional view of cooperating male and female ends of adjacent sections and of a locking assembly illustrated in engagement as viewed in the direction of arrows 3-3 of FIG. 1;

FIG. 4 is a sectional view as viewed in the direction of arrows 4-4 of FIG. 2;

FIG. 5 is an exploded partial perspective view of the male and female ends of adjacent sections and an exploded sectional view of a locking assembly therebetween as viewed in direction of the arrows 5-5 of FIG. 3;

FIG. 6 is a partial perspective view of an extremity of the telescoping hot stick illustrating a tool holder;

FIG. 7 is a longitudinal sectional view of two tubular sections joined telescopically together; and

FIG. 8 is a longitudinal sectional view of a distal end of a modified tubular section and showing in broken lines multiple positions of a button as it transitions axially along the interior of the tubular section.

### DETAILED DESCRIPTION

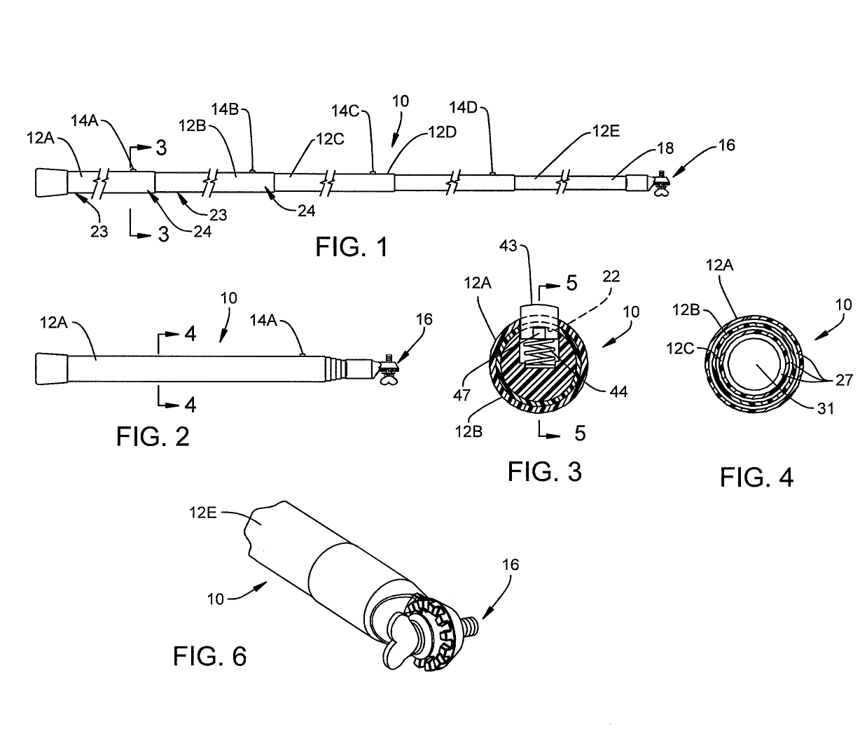

Referring to FIG. 1, the telescopic hot stick or pole of the invention is generally designated by reference numeral 10. The telescoping hot stick 10 includes a predetermined number of similar length, tubular sections 12, i.e. 12A-12E, slidably engaged one with the other which provide a variable length for the hot stick 10, a corresponding number of locking assemblies 14, i.e. 14A-14D, provided between each adjacent section 12 for securing the adjacent sections 12 in extended engagement, and a tool holder 16 at an extremity 18 thereof. To shorten the overall length of the hot stick 10, each section 12 is readily movable as described herein. Each of the tubular sections 12A-12E has a circular cross section.

Each tubular section 12A-12D is generally of the same construction except each successive section 12B-12D is of a smaller diameter. The distal-most tubular section 12E generally will be of a differing construction that does not embrace the thickened wall feature described below. Only the tubular section 12B will be described in detail, it being understood that the tubular section 12A is of a larger diameter and the successively following sections 12C and 12D are of successively smaller diameters. For convenience, the reference numbers used in describing the tubular section 12B will be used in describing the remaining tubular sections except that the particular tubular section will be referenced by the suffix letter that corresponds to that particular tubular section.

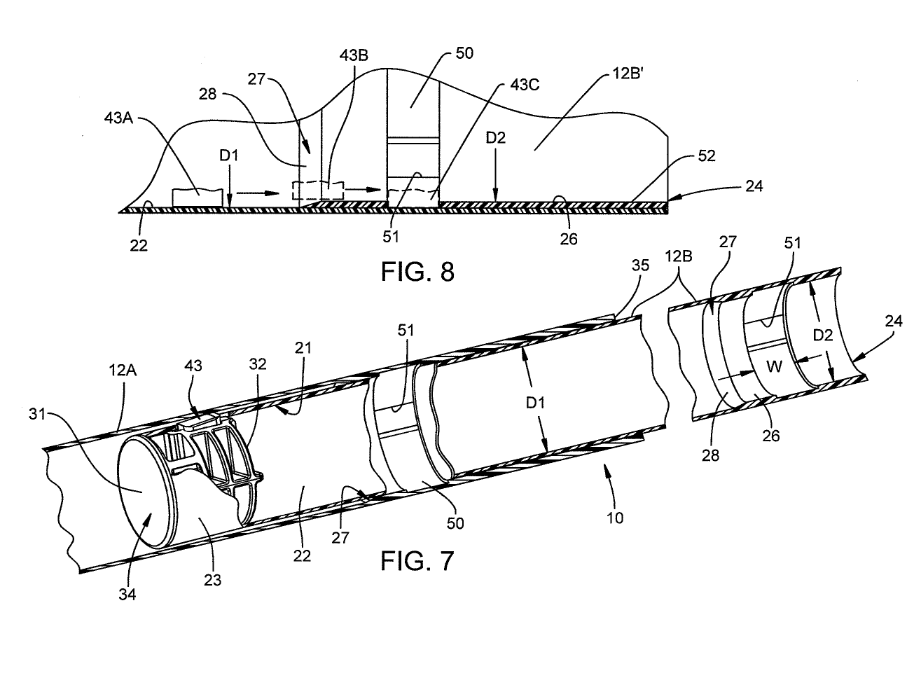

Referring to FIG. 7, the elongate tubular section 12B has a uniform outer diameter throughout its length. On the other hand, the interior wall surface 21 of the section 12B is composed of a first interior wall surface segment 22 that has a first inner diameter D1 extending from the left proximal end 23 toward a distal end 24 a finite distance away from the proximal end 23 and a second interior wall surface segment 26 that has a second inner diameter D2 smaller than the diameter D1 extending from the distal end 24 a finite distance away from the distal end toward the proximal end 23. An inclined ramp 27 having an inclined transition surface 28 (see also FIG. 8) joins the mutually adjacent ends of the first and second interior wall surface segments 22 and 26.

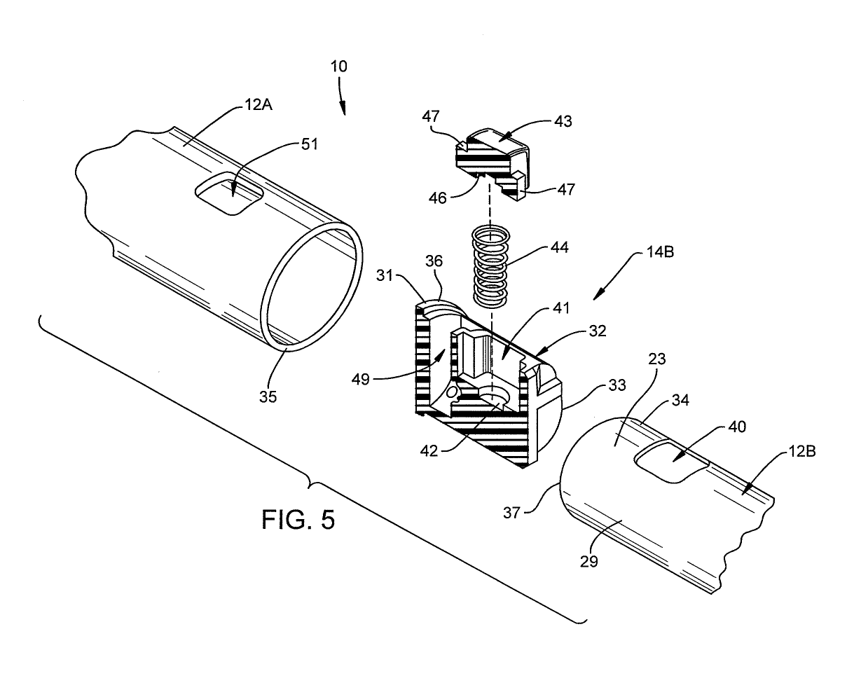

Referring to FIG. 5, the locking assembly 14B includes an end wall portion 31 and a mounting section 32 which are formed of a polymer or any other suitable material. The mounting section 32 is formed with an outer periphery 33 having a circular cross-sectional shape and outer dimension conforming in a close-fit relation to the inner diameter D1 (FIG. 7) of the interior wall surface segment 22 at the male end 34 so as to permit insertion of the mounting section 32 within the male end 34. To limit the extent of insertion of the mounting section 32 therein, the end wall portion 31 is dimensioned so as to form an annular flange 36 which extends radially outward so as to be flush or below flush with the outer periphery 29 of the male end 34. The annular flange 36 (FIG. 5) abuts against an end face 37 of the male end 34 when the locking assembly 14B is fully inserted therein to close off the male end 34. The male end 34 is configured to be slidingly inserted into an adjacent female end 35 of the next following tubular section.

The locking assemblies 14B-14E are each secured inside the respective male end of each section 12B-12E, respectively, by any conventional and conveniently available means.

The tubular section 12B (FIG. 5) has an aperture 40 adjacent the proximal end 23 thereof. Furthermore, the mounting section 32 of the locking assembly 14B includes a pocket 41 the bottom of which defines a spring seat 42. A button 43 is reciprocally movably received in the pocket 41 and projects through the aperture 40 when the locking assembly is fully assembled within the male end 34. A resilient member, here a compression spring 44 is retained between the spring seat 42 and an opposing spring seat 46 formed on the button 43. To keep the button 43 within the pocket 41, when the locking assembly 14B is secured within the male end 34, outwardly extending flanges 47 are stepped so as to contact the internal wall surface segment 22 at the male end 34 when the button 43 is extended as seen in FIG. 3.

The second interior wall surface segment 26 (FIG. 7) has therein, between the ramp 27 and the distal end 24, an annular groove 50 FIG. 8. The depth of the annular groove 50 is, in this particular embodiment, of a diameter that is approximately equal to the diameter D1 and of an axially oriented width “W” that is slightly greater than the corresponding axially extending length dimension of the button 43. An aperture 51 is located within the annular groove 50, which aperture is configured to receive the button 43 and without interfering with the ability of the button to move reciprocally radially inwardly and outwardly therein while the button is aligned with the aperture.

A modified construction adjacent the distal end of a tubular section is shown in FIG. 8. It is, for purposes of this disclosure, assumed that the tubular section can be any one of the many sections involved in this hot stick environment but tubular section 12B has been selected as the particular section for the modified construction and the modified section has been identified by the reference character 12B′. Here, the circular tubular section 12B′ has a uniform wall thickness along its entire length from the proximal end to the distal end. A sleeve 52 circular in cross section of a finite length less than the overall length of the section 12B′ and having an outer diameter approximately equaling the inner diameter D1 of the tubular section 12B′ is inserted into the distal end 24 and affixed to the tubular section 12B′ by any convenient means, such as, for example, by an adhesive, by sonic welding or utilizing self-adhering materials. It is also within the scope of this invention to mold the product so that the thickened portion is integral with the remainder of the tubular section. The ramp 27 is provided at the proximal end of the sleeve either, such as being a molded construction of the sleeve, before the sleeve is inserted into the tubular section 12B′ or is a molded feature on the tube or it is machined into the proximal end of the sleeve after the sleeve has been fixedly secured to the inside of the tubular section 12B′. The annular groove 50 is also provided in the sleeve 52 and is either present at the time of inserting the sleeve into the tubular section 12B′ or is machined into the sleeve after the sleeve has been fixedly secured to the tubular section 12B′. The characteristics of the annular groove 50 in the sleeve 52 are the same as the annular groove 50 described above. An aperture 51 is provided in the tubular section 12B′ and the opens into the annular groove 50 and is configured to receive the button 43 and without interfering with the ability of the button to move reciprocally radially inwardly and outwardly therein while the button is aligned with and received in the aperture 51.

The thickened wall thickness at the distal end of each of the tubular sections 12A-12D as well at the distal end of each tubular section having a sleeve 52 inserted and affixed thereto, or is a molded feature of the tube, is designed to have sufficient axial length and a close-fit slidingly engaged relation with a next immediately adjacent inner telescoped tubular section so that the mutually adjacent male ends 34 and female ends 35 of the respective tubular sections will remain coaxial and amply supported with little or no detectable relative movement therebetween when in the extended relation.

To extend the telescoping sections from the FIG. 2 position to the FIG. 1 position, the user simply pulls the inner disposed tubular sections sequentially axially outwardly of the proximal tubular section so that the respective buttons 43 will slidingly transition along respective (A) first interior wall surface segments 22, (B) the surfaces 28 of the ramps 27 and (C) the second interior wall surface segments 26 to a position where the respective buttons will become aligned with the respective annular grooves, at which time the respective springs 44 will urge the respective buttons into the respective annular grooves as shown in the respective positions “A”, “B” and “C” for the respective buttons 43 shown in the representative example of FIG. 8. Thereafter, the pole containing the button 43 will be rotated relative to the groove containing pole to cause the button to become axially aligned with opening 51 and the spring 44 will urge the button through the opening 51 to thereby lock the poles together so that no relative movement will occur therebetween. It is to be recognized that the button 51 can also be urged by application of a manual force to it radially inwardly to that the top surface of the button becomes oriented radially inside the inner surface 26 of the thicker portion of the tube to thereafter facilitate the relative axial movement between the tube sections for purpose of collapsing the pole sections one within the other, or extending any distal section relative to the immediate proximal section for the purpose of removal of the distal pole section from the proximal pole section and all without the use of tools.

Although particular preferred embodiments of the invention have been disclosed in detail for illustrative purposes to demonstrate the improvement over known constructions, it will be recognized that variations or modifications of the disclosed apparatus of the invention, including the rearrangement of parts, lie within the scope of the present invention.

What is claimed is:

1. A telescoping pole having a proximal end and a distal end for manipulating a tool from a position a selected distance away from a workpiece, said pole having an extremity with means for connecting the tool thereto and further comprising:
a tubular first section circular having a female end and a button capturing annular groove in a first interior surface thereof adjacent the distal end of said first section;
a tubular second section having a male end slidably engaged within said interior of said first section through said female end and along an axial path, a button support mechanism fixedly mounted on and in said interior of said second tubular section adjacent a proximal end of said second tubular section and carrying thereon a radially movable button continually urged radially outwardly and into sliding engagement with said first interior surface on said first tubular section by an elastically resilient member provided on said button support mechanism; and
a button receiving opening located within said annular groove, said first and second tubular sections being configured to move along said axial path relative to one another to effect an extension of length of the telescoping pole to cause said button to enter said annular groove and cause said first and second tubular sections to be temporarily prevented from moving axially with respect to one another while said button is located in said annular groove, said first and second tubular sections being configured to rotate with respect to one another while said button is in said annular groove to allow said button to slide circumferentially in said annular groove until said button becomes axially aligned with said button receiving opening to thereafter enable said resilient member to urge said button radially outwardly and through said button receiving opening.

2. The telescoping pole according to claim 1, wherein said button support mechanism is configured to allow a radially outwardly facing surface on said button to be moved radially inwardly to a location radially inside said first interior surface to facilitate one of a relative axial retracting movement and a relative axial extending movement between said tubular first and second sections upon application of an axial force to at least one pole section, said axial extending movement enabling a separation of said tubular first and second sections without a necessity for tools.

3. The telescoping pole according to claim 1, wherein said first interior surface has a first axially extending surface section having a first diameter adjacent said proximal end and a second axially extending surface section adjacent said distal end having a second diameter less than said first diameter, and an inclined ramp at a proximal end of said second axially extending surface section to provide a transition surface between said first and second axially extending surface sections.

4. The telescoping pole according to claim 3, wherein said button support mechanism is configured to allow a radially outwardly facing surface on said button to be moved while located in said button receiving opening radially inwardly to a location radially inside said second axially extending surface section to facilitate one of a relative axial retracting movement and a relative axial extending movement between said tubular first and second sections upon application of an axial force to at least one pole section, said axial extending movement enabling a separation of said tubular first and second sections without a necessity for tools.

5. The telescoping pole according to claim 3, wherein said annular groove is provided in said second axially extending surface section between said ramp and said distal end of said tubular first section.

6. The telescoping pole according to claim 3, wherein said second axially extending surface section is defined by a tubular insert in said distal end of said tubular first second, said tubular insert being secured to said interior wall surface of said first tubular section.

7. The telescoping pole according to claim 6, wherein said annular groove is provided in an interior surface of said tubular insert between said ramp and said distal end of said tubular insert.

8. The telescoping pole according to claim 1, wherein an axially oriented width of said annular groove is of a sufficient dimension to accommodate therein and with a close tolerance fit said button to prevent any relative axial movement between said first and second tubular sections when said button is received in said annular groove, except for the relative axial movement that may occur due to the tolerance difference between said axially oriented width of said annular groove and an axially oriented width of said button.

9. The telescoping pole according to claim 3, wherein said first resilient member is a compression spring.

10. The telescoping pole according to claim 1, wherein said first interior surface has a first axially extending surface section having a first diameter adjacent said proximal end and a second axially extending surface section adjacent said distal end having a second diameter less than said first diameter, and an inclined ramp at a proximal end of said second axially extending surface section to provide a transition surface between said first and second axially extending surface sections and wherein said first and second tubular sections are configured to move along said axial path relative to one another to effect an extension of length of the telescoping pole to cause said button to sequentially slide axially along said first interior surface having said first diameter, said transition surface and said second interior surface having said second diameter and thence become aligned with said annular groove to enable said resilient member to urge said button into said annular groove to cause said first and second tubular sections to be temporarily prevented from moving axially with respect to one another while said button is located in said annular groove and while at the same time enabling said first and second tubular sections to be permitted to rotate relative to one another to allow said button to slide circumferentially in said annular groove until said button becomes axially aligned with said button receiving opening to thereafter enable said resilient member to urge said button further radially outwardly and through said button receiving opening.

11. The telescoping pole according to claim 3, wherein said second axially extending surface section is defined by a tubular insert in said distal end of said tubular first second, said tubular insert being secured to said interior wall surface of said first tubular section.

12. The telescoping pole according to claim 1, wherein said first and second tubular sections are configured to rotate with respect to one another as said first and second tubular sections are extending with respect to one another.

13. The telescoping pole according to claim 12, wherein said first and second tubular sections are each circular in cross section.
